(19) United States
(12) Patent Application Publication
(10) Pub. No.: US 2010/0278198 A1
(43) Pub. Date: Nov. 4, 2010

(54) METHOD AND APPARATUS FOR PROVIDING QUANTIZATION OF SYNCHRONIZATION SIGNALS

(75) Inventors: Olav Emerik Tirkkonen, Helsinki (FI); Jürgen Michel, Munich (DE); Jiang Yu, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/433,532

(22) Filed: Apr. 30, 2009

(51) Int. Cl. H04J 3/06

(52) U.S. Cl. 370/503

(57) ABSTRACT

An apparatus for providing quantization of synchronization signals may include a processor and a memory storing executable instructions. In response to execution of the instructions by the processor, the apparatus may perform at least receiving an indication of a first variable defining a communication parameter with respect to communications associated with a serving node, receiving an indication of a second variable defining the communication parameter with respect to communications associated with a neighbor node, determining variable information based on a difference between the first variable and the second variable, and providing the variable information to the serving node in a quantized message enabling the serving node to modify a value associated with the first variable to reduce the difference between the first variable and the second variable. A corresponding method and computer program product are also provided.

### TECHNOLOGICAL FIELD

Embodiments of the present invention relate generally to communications technology and, more particularly, relate to an apparatus and method for providing quantization of synchronization signals.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, wireless communication has become increasingly popular in recent years due, at least in part, to reductions in size and cost along with improvements in battery life and computing capacity of mobile electronic devices. As such, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content.

Communication networks and technologies have been developed and expanded to provide robust support for mobile electronic devices. In this regard, telecommunications technologies aimed at providing wireless data over long distances in a variety of ways, from point-to-point links to full mobile cellular type access are being developed and enhanced. Improvements to the global system for mobile communication (GSM) and the universal mobile telecommunications system (UMTS) along with developments related to the evolved UMTS terrestrial radio access network (E-UTRAN) are also currently being pursued. The E-UTRAN, which is also known as Long Term Evolution (LTE) or 3.9G, is aimed at upgrading prior technologies by improving efficiency, lowering costs, improving services, making use of new spectrum opportunities, and providing better integration with other open standards. Development of future wireless networks also includes the development of ad hoc networks, sensor networks and awarenet networks, among others.

In a typical network configuration, for example, mobile users often communicate with each other or with network devices via communication links maintained by the network. The network therefore conducts communication with many devices simultaneously. In wireless networks, it may be useful for nodes within the network to agree on start and end times for various time periods that may exist within the network. In other words, it may be useful for the beginning and end of certain time periods associated with the network nodes to be synchronized. Synchronization of time periods may provide benefits such as power savings, interference avoidance, facilitation of time domain resource sharing, enablement with respect to the performance of collaborative transmission, and/or the like. Synchronization of time periods may be referred to as frame synchronicity, which may be provided, for example, by periodic time alignment. Frame synchronicity may differ from full time synchronization in that full time synchronization may require frame synchronicity and frame number synchronicity.

Frame synchronicity may be provided within a network by a centralized control mechanism. For example, a controller within the network may provide commands (either via wired or wireless links) to the nodes (e.g., base stations, access points, node-Bs, etc.) in order to provide frame synchronicity. However, centralized control mechanisms may not always be practical, desirable, or even possible. For example, for ad hoc networks there may inherently be no centralized control. Furthermore, in some cases, it may be desirable to synchronize networks associated with different operators such as adjacent channel networks or networks employing spectrum sharing. Although synchronization could be accomplished by enabling each node (e.g., base stations, access points, node-Bs, etc.) to directly communicate with each other to access timing information associated with other nodes, such direct communication may also not be desirable in all cases.

Accordingly, it may be desirable to develop other ways of implementing methods of synchronization.

### BRIEF SUMMARY OF EXEMPLARY EMBODIMENTS

A method and apparatus are therefore provided that may enable the provision of quantization of synchronization signals in order to enable synchronization of nodes based on information provided from one or more of the terminals (e.g., mobile terminals) serviced by the nodes. Accordingly, for example, mobile terminals (e.g., user equipment (UE) devices) may provide information on the timing employed at neighboring nodes for use by a particular node to adjust its timing in order to achieve synchronization.

In one exemplary embodiment, a method of providing quantization of synchronization signals is provided. The method may include receiving an indication of a first variable defining a communication parameter with respect to communications associated with a serving node, receiving an indication of a second variable defining the communication parameter with respect to communications associated with a neighbor node, determining variable information based on a difference between the first variable and the second variable, and providing the variable information to the serving node in a quantized message enabling the serving node to modify a value associated with the first variable to reduce the difference between the first variable and the second variable.

In another exemplary embodiment, a computer program product for providing quantization of synchronization signals is provided. The computer program product may include at least one computer-readable storage medium having computer-executable program code instructions stored therein. The computer-executable program code instructions may include program code instructions for receiving an indication of a first variable defining a communication parameter with respect to communications associated with a serving node, receiving an indication of a second variable defining the communication parameter with respect to communications associated with a neighbor node, determining variable information based on a difference between the first variable and the second variable, and providing the variable information to the serving node in a quantized message enabling the serving node to modify a value associated with the first variable to reduce the difference between the first variable and the second variable.

In another exemplary embodiment, an apparatus for providing quantization of synchronization signals is provided. The apparatus may include a processor and a memory storing executable instructions. In response to execution of the instructions by the processor, the apparatus may perform at least receiving an indication of a first variable defining a communication parameter with respect to communications associated with a serving node, receiving an indication of a second variable defining the communication parameter with respect to communications associated with a neighbor node, determining variable information based on a difference between the first variable and the second variable, and providing the variable information to the serving node in a quantized message enabling the serving node to modify a value associated with the first variable to reduce the difference between the first variable and the second variable.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for providing quantization of synchronization signals according to an exemplary embodiment of the present invention;

FIG. 3 shows an example of the monitoring of timing information from various different nodes according to an exemplary embodiment of the present invention;

FIG. 4 illustrates an example timing diagram showing non-synchronized frames for which timing values may be determined to enable communication of timing information to a serving node in accordance with an exemplary embodiment of the present invention;

FIG. 5 shows an example of a timing diagram showing a user equipment (UE) comparing its own timing with respect to communications with a serving node to timing associated with various neighbor nodes in accordance with an exemplary embodiment of the present invention; and

FIG. 6 illustrates a flowchart of a method of providing quantization of synchronization signals in accordance with an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to providing quantization of synchronization signals. In this regard, for example, information may be transmitted from one or more terminals to serving nodes (e.g., base stations, access points, node Bs, etc.) to convey information about the timing of one or more other serving nodes. The information may be signaled over a digital communications channel and is therefore quantized. Thus, embodiments of the present invention further describe examples of ways such information may be quantized. Accordingly, some embodiments of the present invention may provide operations to enable the quantization of signals conveying timing information for use in synchronizing neighboring nodes.

In general terms, embodiments of the present invention may provide information related to a variable with respect to which a communication node and its neighboring node(s) are attempting to reach a consensus (e.g., synchronization) in a self-organized manner. As such, for example, embodiments of the present invention relate to the provision of messages that convey information about a difference between two values of a variable (e.g., the starting or ending timing associated with a particular time period). The messages may then enable the nodes to reach a consensus regarding an applicable value for the variable. In some cases, there may be an accuracy target associated with the variable and a range for possible differences associated with the variable. Accordingly, one exemplary embodiment of the present invention may provide for the quantization of the differences in unequal steps so that, for example, at least two small difference values can be signaled, and at least one large difference value can be signaled. The smallest value of the difference value that can be signaled may be set to be equal to or less than the accuracy target and the large difference value may be set to be a particular fraction of the range.

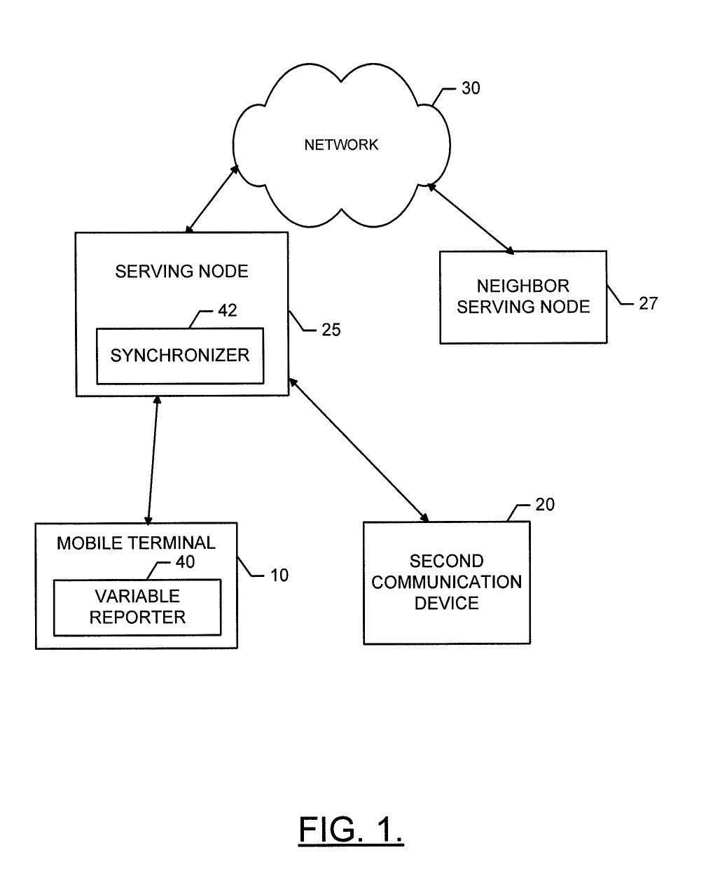

FIG. 1 illustrates a generic system diagram in which several terminals (e.g., including a mobile terminal 10 and a second communication device 20) are in shown communication with at least one serving node 25, which may benefit from embodiments of the present invention, in an exemplary communication environment. In this regard, the mobile terminal 10 and/or the second communication device 20 may be configured to provide timing information regarding timing values associated with neighboring nodes (e.g., neighbor serving node 27) to the serving node 25, to enable the serving node 25 to make timing adjustments for synchronization with the neighboring serving node 27 and/or other neighboring nodes.

As shown in FIG. 1, an embodiment of a system in accordance with an example embodiment of the present invention may include a first communication device (e.g., mobile terminal 10) and other communication devices (e.g., the second communication device 20) capable of communication with each via a network 30. The network 30 may be a single network or multiple networks of various different types. Meanwhile, the serving node 25 and the neighbor serving node 27 may each be associated with the same network, or may be associated with different networks. In some cases, embodiments of the present invention may further include one or more network devices with which the mobile terminal 10 and/or the second communication device 20 may communicate to provide, request and/or receive information. It should be noted that although FIG. 1 shows a communication environment that may support client/server application execution, in some embodiments, the mobile terminal 10 and/or the second communication device 20 may employ embodiments of the present invention without any network communication. As such, for example, transmissions from terminals acting as nodes within a device-to-device network may also benefit from embodiments of the present invention.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30.

One or more communication terminals such as the mobile terminal 10 and the second communication device 20 may be in communication with each other via nodes of the network 30 and each may include an antenna or antennas for transmitting signals to and for receiving signals from nodes (e.g., the serving node 25 and the neighbor serving node 27) such as a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 20 via the nodes of the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and/or the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a personal digital assistant (PDA), wireless telephone, mobile computing device, camera, video recorder, audio/video player, positioning device, game device, television device, radio device, or various other like devices or combinations thereof. The second communication device 20 may also be a mobile device such as those listed above or other mobile devices, but could also be a fixed communication device (e.g., a personal computer, relay station or the like) in some instances.

In an exemplary embodiment, either or both of the mobile terminal 10 and the second communication device 20 may be configured to include or otherwise employ a variable reporter 40 according to an exemplary embodiment. Meanwhile, the serving node 25 (and possibly also the neighbor serving node 27) according to this example includes a synchronizer 42. The synchronizer 42 may be any means such as a device or circuitry operating in accordance with software or otherwise embodied in hardware or a combination of hardware and software (e.g., a processor of the serving node operating under software control, the processor of the serving node embodied as an ASIC or FPGA specifically configured to perform the operations described herein, or a combination thereof) thereby configuring the device or circuitry to perform the corresponding functions of the synchronizer 42 as described herein.

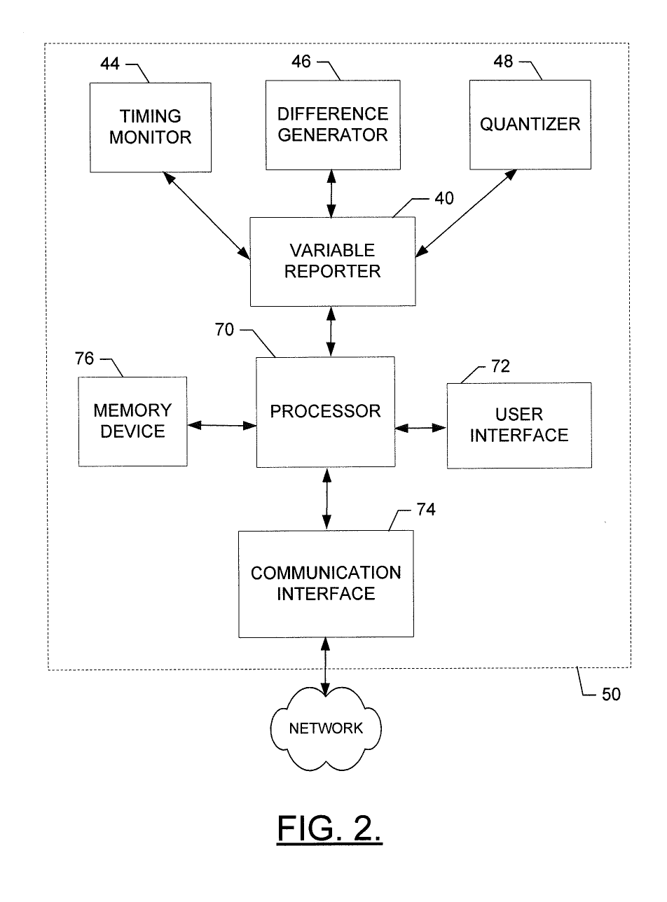

The variable reporter 40 is shown and described in greater detail below in connection with FIG. 2. However, in general terms, the variable reporter 40 may be configured to measure timing information related to transmissions received from various serving nodes and determine differences between the timing used by each respective serving node in connection with the transmissions monitored. The variable reporter 40 may then be configured to provide quantization for messages reporting information associated with the timing differences determined for communication of the messages to one or more of the nodes.

FIG. 2 illustrates a schematic block diagram of an apparatus for providing quantization of synchronization signals according to an exemplary embodiment of the present invention. An exemplary embodiment of the invention will now be described with reference to FIG. 2, in which certain elements of an apparatus 50 for providing an indication of device to device communication capability are displayed. The apparatus 50 of FIG. 2 may be employed, for example, on a communication device (e.g., the mobile terminal 10 and/or the second communication device 20) or a variety of other devices (e.g., desktops and servers), both mobile and fixed (such as, for example, any of the devices listed above). However, it should be noted that the components, devices or elements described below may not be mandatory and thus some may be omitted in certain embodiments. Additionally, some embodiments may include further components, devices or elements beyond those shown and described herein.

Referring now to FIG. 2, an apparatus for providing an indication of device to device communication capability is provided. The apparatus 50 may include or otherwise be in communication with a processor 70, a user interface 72, a communication interface 74 and a memory device 76. The memory device 76 may include, for example, one or more volatile and/or non-volatile memory devices. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as various processing means such as one or more instances of a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may in some cases otherwise be a general purpose processing element or other functionally configurable circuitry if not for the specific configuration provided by the instructions, to perform the algorithms and/or operations described herein when the instructions are executed. However, in some cases, the processor 70 may be a processor of a specific device (e.g., a mobile terminal or network device such as a serving node) adapted for employing embodiments of the present invention by further configuration of the processor 70 by instructions for performing the algorithms and/or operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control the variable reporter 40. The variable reporter 40 may further include or otherwise control a timing monitor 44, a difference generator 46 and a quantizer 48. The variable reporter 40, the timing monitor 44, the difference generator 46 and the quantizer 48 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the variable reporter 40, the timing monitor 44, the difference generator 46, and the quantizer 48, respectively, as described below. Thus, in examples in which software is employed, a device or circuitry (e.g., the processor 70 in one example) executing the software forms the structure associated with such means. In this regard, for example, the variable reporter 40 may be configured to monitor and measure timing differences (or differences between other variables utilized by multiple serving nodes) between nodes and provide information (e.g., in quantized messages) based on the timing differences to at least one of the nodes. The monitoring and measurement of timing differences may be accomplished by the timing monitor 44, which may be configured to monitor the timing of transmissions made by various nodes that are received at the apparatus 50. Meanwhile, the difference generator 46 may be configured to compare the timing of the monitored transmissions in order to enable the determination of timing differences therebetween. The quantizer 48 may be configured to provide quantization of the determined timing differences for inclusion in messages transmitted from the apparatus 50 to at least one of the nodes.

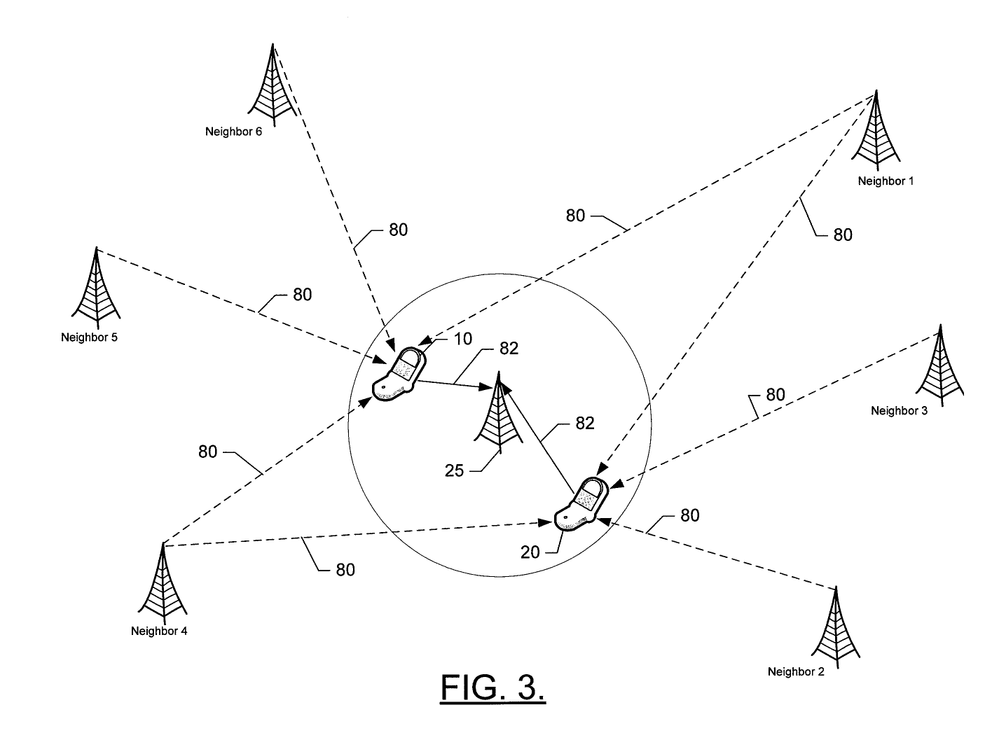

FIG. 3 shows an example of the monitoring of timing information from various different nodes according to an exemplary embodiment. In this regard, FIG. 3 illustrates a serving base station (BS) as an example of the serving node 25 of FIG. 1. FIG. 3 also illustrates one example of the mobile terminal 10 and the second communication device 20 in a communication environment in which communication is possible with the serving BS and various ones of different neighboring serving nodes (e.g., neighbor 1, neighbor 2, neighbor 3, neighbor 4, neighbor 5 and neighbor 6). In the example of FIG. 3, the mobile terminal 10 receives timing values 80 from neighbor 1, neighbor 4, neighbor 5 and neighbor 6. Meanwhile, the second communication device receives timing information 80 from neighbor 1, neighbor 2, neighbor 3 and neighbor 4. An instance of the variable reporter 40 at either or both of the mobile terminal 10 and the second communication device 20 may monitor the timing values 80 received from the various neighboring serving nodes from which the mobile terminal 10 and the second communication device 20, respectively, receive frame data (e.g., via an instance of the timing monitor 44). The variable reporter 40 (e.g., via the difference generator 46) may then determine timing differences between the timing values 80 and corresponding timing related values (as examples of a variable) utilized by the serving BS. The variable reporter 40 (e.g., via the quantizer 48) may then quantize the timing differences into messages that may be sent to the serving BS as timing information 82.

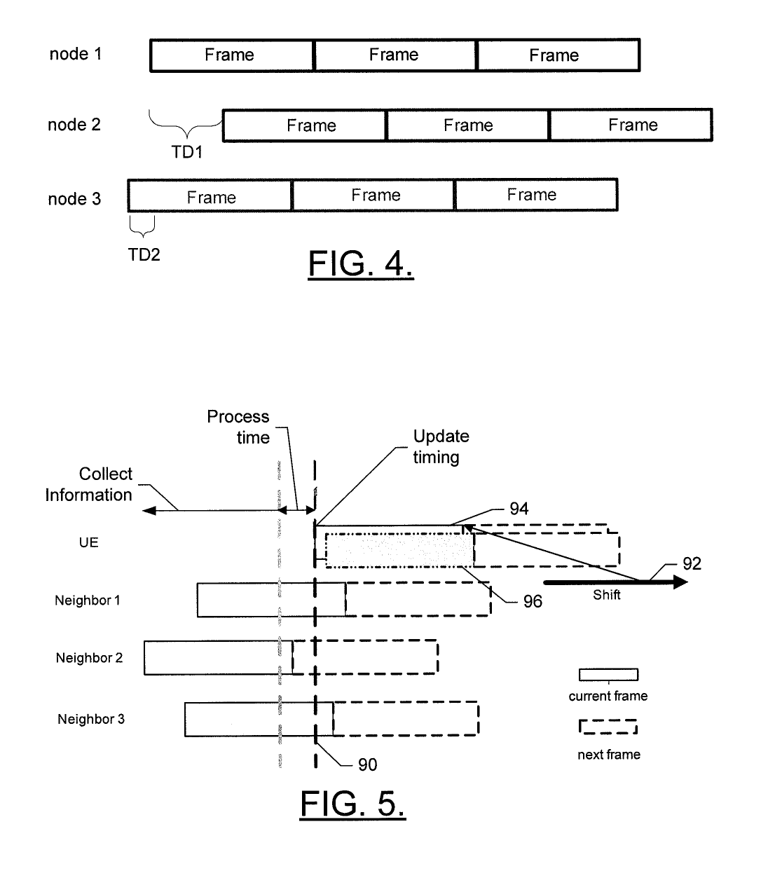

In an exemplary embodiment, the timing associated with various ones of the neighboring serving nodes may initially be non-synchronized (e.g., as shown in the example of FIG. 4 which illustrates non-synchronized frames for which timing values may be determined to enable communication of timing information to the serving BS in accordance with an exemplary embodiment). In this regard, the value TD1 may represent the timing difference between the start of corresponding frames of node 1 (e.g., the serving BS) and node 2 (e.g., a neighboring service node). Meanwhile, the value TD2 may represent the timing difference between the start of corresponding frames of node 1 and node 3 (e.g., another neighboring service node). The timing difference values may be determined by the difference generator 46 by comparing frame start (or end) times to each other.

In an exemplary embodiment, the timing information 82 may be provided to a first node (e.g., the serving node 25) in a message to relate timing differences between the first node and at least one other node (e.g., one or more of the neighbor serving nodes 27). In some cases (such as when the serving node and the neighbor serving nodes 27 are capable of directly communicating with each other) the timing information 82 could be provided by neighbor serving nodes themselves to the first node. However, in an example case, the terminals (e.g., mobile terminal 10 and/or the second communication device 20) may provide the timing information as shown in FIG. 3. The timing information 82 may be determined by the difference generator 46 by calculating a difference between a first value and a second value where the first value may be:
1) a value of a variable (e.g., frame timing) signaled by the first node at some time instance in the past:
2) a value of a variable used by the first node at a time instance in the past (e.g., measured from a signal waveform used for transmission by the first node);
3) a time domain filtered value constructed from multiple instances of variables used or signaled by the first node at a time instance in the past;
4) a value of a variable signaled by a second node (e.g., one of the neighbor serving nodes) at a time instance in the past;
5) a value used by the second node at a time instance in the past;
6) a time domain filtered value constructed from multiple instances of a value used or signaled by the second node at a time instance in the past;
7) a filtered (e.g., averaged, randomly selected or weighted average) value of a variable signaled by a third or subsequent node (e.g., another one or more of the neighboring serving nodes) at a time instance in the past; or
8) a filtered (e.g., averaged, randomly selected or weighted average) value of a variable used by a third or subsequent node at a time instance in the past.
   In an exemplary embodiment, the second value may be any of option 4 through option 8 above.

In an exemplary embodiment, the mobile terminal 10 may act as an intermediate node with respect to transmission of variable information to the first node regarding value differences between the first node and one or more other neighbor serving nodes and the variable may be frame timing. Thus, for example, the first value may be frame timing used by the first node and the second value may be frame timing used at one or more of the second, third or subsequent nodes. In this regard, the second value could be an average value of frame timings of a plurality of other nodes or individual values for one or more of the plurality of other nodes. In some situations, multiple terminals may provide variable information to the serving node 25 based on the variable information associated with the neighbor serving nodes with which the corresponding terminals are capable of communicating.

As an example, a synchronization target may be provided to define a desired synchronization accuracy of 1 μs (e.g., well within the cyclic prefix defined for LTE). The range of timing differences may be [−2500,2500] μs, corresponding to the uplink/downlink switching period of LTE TDD (timing duplex division) and full information about the timing difference may be provided with 13 bits. The quantizer 48 may provide quantization for generation of messages that transfer variable information (e.g., the timing information 82) to the serving node 25. With one bit, the bit may indicate the direction of time difference and the step size of the quantization may be one or less.

FIG. 5 shows an example of a UE (e.g., the mobile terminal 10) comparing its own timing with respect to communications with the serving node 25 to timing associated with various neighbor nodes. As can be seen from FIG. 5, the UE collects information for a certain period and then processes the information to determine timing differences between frame start or end times. In the example of FIG. 5, neighbor 1 and neighbor 3 have timings on the right side of (e.g., after) the UE's current timing which starts at a time indicated by dotted line 90, while neighbor 2 has a timing on the left side of (e.g., before) the UE's current timing with the serving node 25. Based, for example, on an average of the three neighbor timings, the UE may determine that a timing shift of approximately one slot to the right should be inserted. The UE may then provide timing information 82 in a message to the serving node 25 indicating a timing shift to the right as indicated by arrow 92. The synchronizer 42 of the serving node 25 may receive the timing information 82 (which may be quantized by the quantizer 48) and initiate a timing shift to move the frame timing temporally to the right as shown by the modified frame 94, which is shifted to the right with respect to the original frame 96. Thus, even one bit of information may be used to enable the serving node 25 to make synchronization related timing adjustments.

In an exemplary embodiment, the quantizer 48 may be configured to quantize messages providing variable information via quantization employed with unequal step sizes. In this regard, for example, if the message providing the timing information is quantized by the quantizer 48 to more than one bit, but fewer than the full information (e.g., 13 bits), the bits may be provided to include not only an indication of the direction of shift, but also a specific value of time slots or some information identifying a step size of the shift. In this regard, with two bits the step size could be, for example, [±1, ±500] or [0, 1, −50, 500], where the smallest step size is based on the accuracy target and the larger step size is selected based on a desired fraction of the range (e.g., 1/10^{th} of the range from −2500 to 2500 in this example). The smallest step sizes should be selected according to the accuracy target. Sometimes it may be beneficial to be able to signal that the target is met with step size 0, and to use different step sizes for positive and negative increments. With three bits, the alternatives for selecting step sizes may include, for example, [±1, ±100, ±500, ±1000] or [0, ±1, ±100, ±500, 1000], and with four bits [±1, ±10, ±25, ±50, ±100, ±250, ±500, ±1000] or [0, ±1, ±10, ±25, ±50, ±100, ±250, ±500, 1000]. As can be seen from the examples above, in some instances the quantizer 48 may be configured to select step sizes that are exponential and may provide that the largest step size is in a range of about 10% to 20% of the full range. Furthermore, when multiple bits are employed, the quantizer 48 may be configured to signal a zero value to indicate no difference in addition to being able to signal small changes of ±1.

In an exemplary embodiment in which the messages are transmitted by intermediate nodes (e.g., the mobile terminal 10 and/or the second communication device 20), and there are, on average, multiple such intermediate nodes per serving node, the unequal quantization may be realized by configuring the intermediate nodes to transmit differently quantized information. Thus, for example, some terminals (e.g., the mobile terminal 10, the second communication device 20 and/or UEs) may quantize the timing difference to direction (e.g., [+1/−1]) and some may quantize the absolute value (e.g., [−500/+500]). Combining messages from multiple intermediate nodes, the 2-bit information may be acquired.

In another exemplary embodiment, some terminals may quantize a timing difference to, for example, [+1/+500] and other terminals may quantize the timing difference to [−1/−500]. Compared to the example above, this may be advantageous if periodic signaling from terminals is accomplished and if there is no zero step size included in the set of code words. Furthermore, as described above, combining messages from two intermediate nodes providing directionally limited timing difference information may enable the 2-bit information to be acquired.

Some exemplary embodiments of the present invention may provide for a savings of overhead of a channel used to transmit timing information and better overall performance for rough synchronization. As an example, if one considers a timing difference quantization in a case where the range is 1000 times the accuracy target, examples of unequal quantization of the timing differences that may be employed include [±1, ±100], [0, ±1, ±25, ±100], and [0, ±1, ±2, ±5, ±10, ±20, ±50, ±100] for 2, 3, and 4 bits, respectively. The simulation therein shows that this quantization works well for self-organized synchronization. Four bits provide very good performance.

In some cases, rather than averaging timing data from all neighbors, timing decisions may be made based on simple algorithms associated with using the timing information provided from one randomly chosen neighbor (e.g., random selection). By performing random selection for quantization of variable (e.g., timing) information, performance may be improved with respect to the use of full timing information. Moreover, the use of unequal quantization steps may avoid or at least mitigate negative impacts associated with severe timing fluctuations in the system by providing at least rough synchronization. In general, the higher the number of bits employed in the messages providing timing information, the faster at least rough synchronicity may be reached. Thus, as an alternative to using full information, unequal quantization over fewer bits may enable synchronization in a faster manner.

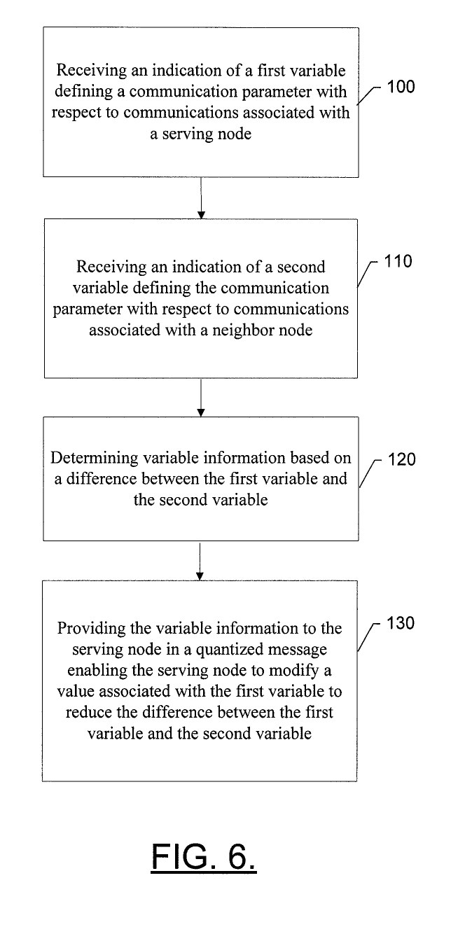

FIG. 6 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing quantization of synchronization signals, as shown in FIG. 6, includes receiving an indication of a first variable defining a communication parameter with respect to communications associated with a serving node at operation 100 and receiving an indication of a second variable defining the communication parameter with respect to communications associated with a neighbor node at operation 1 10. Thus, in a scenario in which the serving node and neighbor node are in communication with a terminal, operation 100 may provide an indication of the first variable defining a communication parameter with respect to communications between the terminal and the serving node, while operation 1 10 may provide an indication of the second variable defining a communication parameter with respect to communications between the terminal and the neighbor node. However, in a device-to-device communication context, the serving node and the neighbor node may themselves be terminals or access points. The method may further include determining variable information based on a difference between the first variable and the second variable at operation 120 and providing the variable information to the serving node in a quantized message enabling the serving node to modify a value associated with the first variable to reduce the difference between the first variable and the second variable at operation 130.

In some embodiments, certain ones of the operations above may be modified or further amplified as described below. It should be appreciated that each of the modifications or amplifications herein may be included with the operations and modifications above either alone or in combination with any others among the features described herein. In this regard, for example, receiving the indications of the first variable and the second variable may include receiving an indication of timing associated with the start or end of a data frame. Moreover, in some cases, determining variable information may include determining timing information such as a direction and magnitude of a shift in timing associated with a data frame start or end time. In some cases, providing the variable information to the serving node in the quantized message may include providing unequal quantization steps. The unequal quantization steps may include a smallest step to indicate a direction associated with the timing difference and/or a largest step selected to indicate a predefined fraction of a range associated with the timing difference. In some cases, providing unequal quantization steps may include providing step sizes that increase exponentially.

In an exemplary embodiment, an apparatus for performing the method of FIG. 6 above may comprise a processor (e.g., the processor 70) configured to perform some or each of the operations (100-130) described above. The processor may, for example, be configured to perform the operations (100-130) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-130 may comprise, for example, the processor 70, the variable reporter 40, respective ones of the timing monitor 44, the difference generator 46 and the quantizer 48, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least perform the following:
receiving an indication of a first variable defining a communication parameter with respect to communications associated with a serving node;
receiving an indication of a second variable defining the communication parameter with respect to communications associated with a neighbor node;
determining variable information based on a difference between the first variable and the second variable; and
providing the variable information to the serving node in a quantized message enabling the serving node to modify a value associated with the first variable to reduce the difference between the first variable and the second variable.

2. The apparatus of claim 1, wherein instructions for receiving the indications of the first variable and the second variable include instructions for receiving an indication of timing associated with the start or end of a data frame.

3. The apparatus of claim 1, wherein instructions for determining variable information include instructions for determining timing information.

4. The apparatus of claim 1, wherein instructions for providing the variable information to the serving node in the quantized message include instructions for providing unequal quantization steps.

5. The apparatus of claim 4, wherein instructions for providing unequal quantization steps include instructions for providing a smallest step to indicate a direction associated with the timing difference.

6. The apparatus of claim 4, wherein instructions for providing unequal quantization steps include instructions for providing a largest step to indicate a predefined fraction of a range associated with the timing difference.

7. The apparatus of claim 1, wherein instructions for providing unequal quantization steps include instructions for providing step sizes that increase exponentially.

8. A method comprising:
receiving an indication of a first variable defining a communication parameter with respect to communications associated with a serving node;
receiving an indication of a second variable defining the communication parameter with respect to communications associated with a neighbor node;
determining variable information based on a difference between the first variable and the second variable; and
providing the variable information to the serving node in a quantized message enabling the serving node to modify a value associated with the first variable to reduce the difference between the first variable and the second variable.

9. The method of claim 8, wherein receiving the indications of the first variable and the second variable comprises receiving an indication of timing associated with the start or end of a data frame.

10. The method of claim 8, wherein determining variable information comprises determining timing information.

11. The method of claim 8, wherein providing the variable information to the serving node in the quantized message comprises providing unequal quantization steps.

12. The method of claim 1 1, wherein providing unequal quantization steps comprises providing a smallest step to indicate a direction associated with the timing difference.

13. The method of claim 11, wherein providing unequal quantization steps comprises providing a largest step to indicate a predefined fraction of a range associated with the timing difference.

14. The method of claim 8, wherein providing unequal quantization steps comprises providing step sizes that increase exponentially.

15. A computer program product comprising at least one computer-readable storage medium having computer-executable program code portions stored therein, the computer-executable program code portions comprising:
program code instructions for receiving an indication of a first variable defining a communication parameter with respect to communications associated with a serving node;
program code instructions for receiving an indication of a second variable defining the communication parameter with respect to communications associated with a neighbor node;
program code instructions for determining variable information based on a difference between the first variable and the second variable; and
program code instructions for providing the variable information to the serving node in a quantized message enabling the serving node to modify a value associated with the first variable to reduce the difference between the first variable and the second variable.

16. The computer program product of claim 15, wherein program code instructions for receiving the indications of the first variable and the second variable include instructions for receiving an indication of timing associated with the start or end of a data frame.

17. The computer program product of claim 15, wherein program code instructions for determining variable information include instructions for determining timing information.

18. The computer program product of claim 15, wherein program code instructions for providing the variable information to the serving node in the quantized message include instructions for providing unequal quantization steps.

19. The computer program product of claim 18, wherein program code instructions for providing unequal quantization steps include instructions for providing a smallest step to indicate a direction associated with the timing difference.

20. The computer program product of claim 19, wherein program code instructions for providing unequal quantization steps include instructions for providing a largest step to indicate a predefined fraction of a range associated with the timing difference.
